(19) United States
(12) Patent Application Publication
(10) Pub. No.: US 2016/0124991 A1
(43) Pub. Date: May 5, 2016

(54) METHOD AND APPARATUS FOR MANAGING METADATA FILES

(71) Applicant: THOMAS LICENSING, Issy-les-Moulineaux (FR)

(72) Inventors: Oliver KAMPHENKEL, Lehrte (DE); Thomas BRUNE, Hannover (DE)

(21) Appl. No.: 14/894,384

(22) PCT Filed: May 16, 2014
(86) PCT No.: PCT/EP2014/060106

§ 371 Date: Nov. 27, 2015

(30) Foreign Application Priority Data
May 27, 2013 (EP) 13305691.1

(51) Int. Cl. G06F 17/30; H04N 7/18

(52) U.S. Cl. CPC G06F 17/30221; H04N 7/183; G06F 17/3012

(57) ABSTRACT

A method for metadata files and an apparatus configured to perform managing of metadata files. A metadata file is retrieved via an input. A metadata analyzer then determines information within the metadata file related to at least a hierarchy domain and a temporal domain. Based on the determined information within the metadata file, a data management unit creates entries in the hierarchy domain and/or in the temporal domain, further creates references between the entries and the metadata file, and establishes cross domain relations between the entries in the hierarchy domain and in the temporal domain. The entries, references, and cross domain relations created and established by the data management unit are then stored in a storage unit.

### FIELD OF THE INVENTION

The invention relates to a method and to an apparatus for managing metadata files. More specifically, a method and an apparatus are described, which allow managing of information contained in metadata files over multiple domains.

### BACKGROUND OF THE INVENTION

When metadata of a content production process is collected and managed, there are usually different files from very different sources. For example, during a movie production process metadata are gathered from camera devices, motion trackers, microphones, etc. These files contain information of different aspects of the production. For example, the production script contains information about a movie plot, characters, etc. of scenes of a film. The camera metadata file contains technical recording data, such as lens settings or camera type. This information is isolated in separate files and in different portions with different interrelations. Usual repositories can incorporate and manage those files and display their content. However, such repositories are not able to answer requests to obtain all metadata of a scene, a shot, or a take, to obtain all metadata of a certain time, to check whether all available metadata of a scene, a shot, or a take have been added to the repository, or to check if the metadata information is consistent. One solution to this problem would be to ensure that different sources coordinate the generation of metadata, e.g. that the different sources generate metadata that contain synchronized unique identifiers. However, this is not the case today and is very difficult to implement in view of the huge number of available sources.

U.S. 2010/0042650 discloses, among others, a video editing application. A file comprising metadata associated to a video clip is selected and parsed by a parser. Metadata extracted by the parser is stored in a storage and displayed to support editing.

U.S. 2002/0199204 discloses a method for generating a description in a markup language of a structure of a multimedia content. Based on a metadata file with the description in the markup language both a hierarchically structured view and a linked temporal view are generated.

### SUMMARY OF THE INVENTION

It is an object of the invention to provide a more versatile solution for managing metadata files, which is capable of handling complex requests.

According to one aspect of the invention, a method for managing metadata files comprises the steps of:
retrieving a metadata file;
determining information within the metadata file related to at least a hierarchy domain or a temporal domain;
creating entries in the hierarchy domain and/or in the temporal domain based on the determined information within the metadata file;
creating references between the entries and the metadata file;
establishing cross domain relations between the entries in the hierarchy domain and in the temporal domain; and
storing the created entries, the created references, and the established cross domain relations.

Accordingly, an apparatus configured to manage metadata files comprises:
an input configured to retrieve a metadata file;
a metadata analyzer configured to determine information within the metadata file related to at least a hierarchy domain or a temporal domain;
a data management unit configured to create entries in the hierarchy domain and/or in the temporal domain based on the determined information within the metadata file, to create references between the entries and the metadata file, and to establish cross domain relations between the entries in the hierarchy domain and in the temporal domain; and
a storage unit configured to store the entries, the references, and the cross domain relations created and established by the data management unit.

Similarly, a computer readable storage medium has stored therein instructions enabling managing of metadata files, which when executed by a computer, cause the computer to:
retrieve a metadata file;
determine information within the metadata file related to at least a hierarchy domain or a temporal domain;
create entries in the hierarchy domain and/or in the temporal domain based on the determined information within the metadata file;
create references between the entries and the metadata file;
establish cross domain relations between the entries in the hierarchy domain and in the temporal domain; and
store the created entries, the created references, and the established cross domain relations.

An apparatus according to the invention, i.e. a metadata repository, manages the metadata files, respectively the information parts of the files, in those domains it has references to. These domains are on the one hand a hierarchy domain and on the other hand one or more temporal domains. For example, a production script of a movie contains information about the shots of a scene. In that case a certain shot or scene constitutes a hierarchical entity, i.e. an entry in the hierarchy domain. In contrast, a recording report contains temporal marks of captured camera clips, preferably in the formats of SMPTE timecodes or time of day indications. Those temporal marks are represented in the management structure as time entries in temporal domains. The management structure of the repository is able to maintain multiple references from a file, respectively its information parts, to entities in a hierarchical structure, i.e. entries in the hierarchy domain, and/or to entries in time structures. The metadata information is inherited in the hierarchy domain, e.g. from a scene to its shots, and also in the temporal domains. Information from multiple sources with a reference to the same SMPTE timecode or time of day indication is connected. Beyond that the repository has a cross domain inheritance. When a hierarchy entity has a reference to a file which in turn has a reference to entries in the time domains, the hierarchy entity inherits the metadata information from corresponding time entries. And vice versa, metadata is inherited from hierarchy entities to time entries.

Using the gathered information the repository is able to detect and build connections and interrelations between metadata information, i.e. to compose a set of all metadata of a certain time entry or a certain hierarchy entity. Beyond that it is able to check if the metadata is consistent on different levels and domains, e.g. if the mapping between time of day and SMPTE timecode is always synchronized. The repository can also check for completeness or progress, i.e. it can check for a certain metadata in the hierarchy domain or in temporal domain. For example, the repository is able to determine if there is a recording report for all time entries or all hierarchy entities available.

For a better understanding the invention shall now be explained in more detail in the following description with reference to the figures. It is understood that the invention is not limited to this exemplary embodiment and that specified features can also expediently be combined and/or modified without departing from the scope of the present invention as defined in the appended claims.

### BRIEF DESCRIPTION OF THE DRAWINGS

FIG. 1 depicts a repository structure of a production script;

FIG. 2 illustrates a repository structure of camera metadata;

FIG. 3 depicts a repository structure with recording report;

FIG. 4 shows an information repository with multiple files;

FIG. 5 schematically illustrates a method according to the invention for managing metadata files; and

FIG. 6 depicts an apparatus configured to implement the method of FIG. 5.

### DETAILED DESCRIPTION OF A PREFERRED EMBODIMENT

In the following the invention shall be explained with reference to metadata files generated during a movie production process. Of course, the invention is not limited to this kind of metadata. It is likewise applicable to metadata arising from other type of production processes, e.g. production of an album with musical compositions, production of a TV show or a commercial, or even production of a newspaper or a magazine, where texts and images from different sources as well as layout information need to be handled.

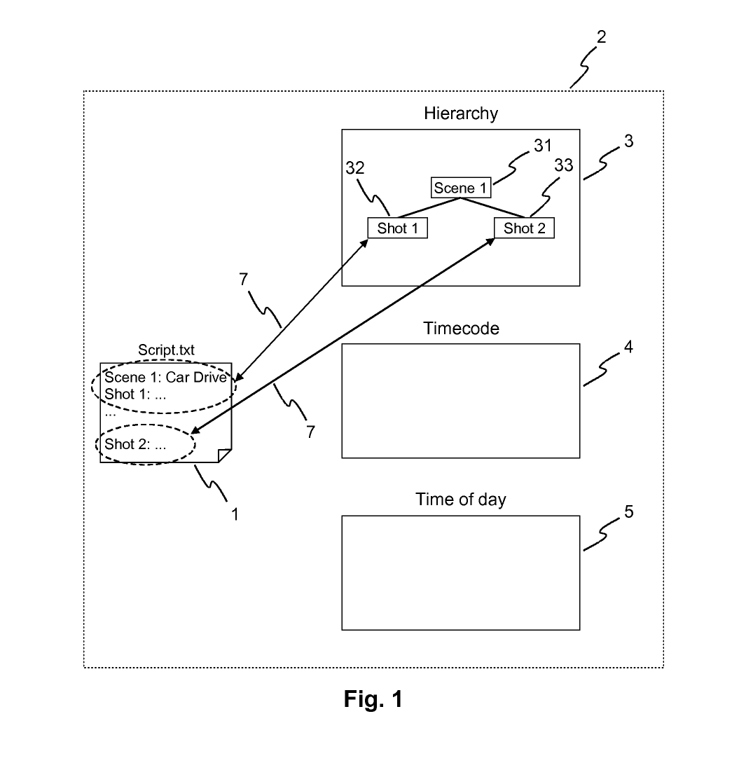

All different metadata files 1 arising during production are added to an apparatus 2 configured to manage metadata, i.e.to a repository. When a metadata file 1 is added to the repository 2, the file is split into information parts that have a reference to a hierarchical entity, i.e. an entry in the hierarchy domain, and/or to a time entry. Those entries are generated in the repository management structure and references 7 to the metadata file 1 are created. In the figures, the references 7 are indicated by the solid arrows. The references 7 are preferably managed in one or more tables of references. For example, the production script contains information about the plot and characters of the shots of a scene. FIG. 1 depicts the entries that are created in the hierarchy domain 3 and the corresponding references 7 when such a file 1 is added to the repository 2. In particular, references to an entry ‘Scene 1’ 31 comprising a ‘Shot 1’ 32 and a ‘Shot 2’ 33 are created in the repository 2. More generally speaking, the repository 2 contains information about which metadata the production script contains of a certain hierarchical entity.

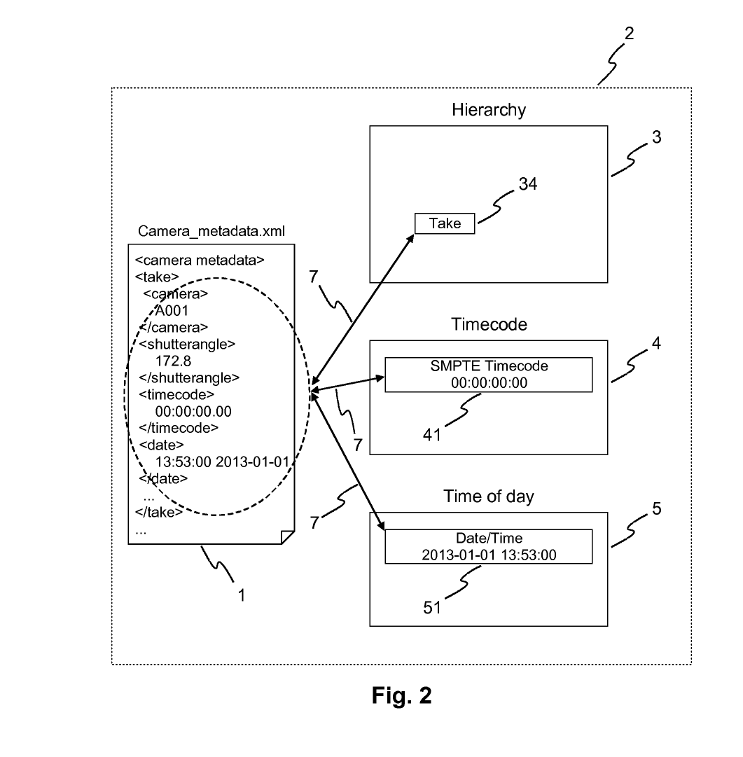

If the information parts of a file 1 also contain data about time relations, references 7 to the temporal structures are also created. Example of such temporal structures are SMPTE timecodes (SMPTE: Society of Motion Picture and Television Engineers) and time of day. FIG. 2 depicts the entries 41, 51 that are created in temporal domains 4, 5 and the corresponding references 7 when a metadata file 1 with camera metadata is added to the repository 2. Camera metadata usually contains time information, i.e. an indication about when a take has been shot, as well as the settings of a camera, e.g. technical settings. Using this information, references 7 to the time entries and to a hierarchy level, here the level of a ‘Take’, can be created in the repository 2, but not to a specific hierarchical entity. In other words, the repository 2 contains the metadata information of a camera for a given time entry 41, 51 and located on a given hierarchy level, i.e. ‘Take’. It is, however, not known which take it is, i.e. to which shot of which scene the take belongs.

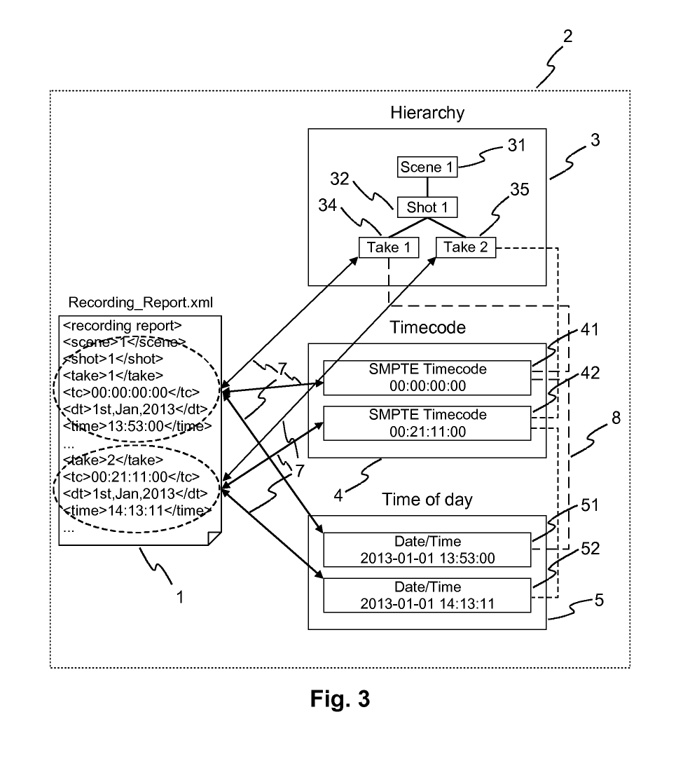

There are also metadata files 1 that contain information in the temporal domains as well as in the hierarchy domain, e.g. a recording report. As depicted in FIG. 3, a metadata file 1 with a recording report contains information about when a certain take has been shot. Information in the temporal domains 4, 5 are thus SMPTE timecodes and the time of day, whereas information in the hierarchy domain 3 are scene, shot, and take entities. This information is incorporated in the repository 2 using entries 31, 32, 34, 35, 41, 42, 51, 52 and references 7 to the temporal and hierarchical management structures. By means of the references 7 from the file 1 or information parts of the file 1 to the different domains 3, 4, 5, cross domain relations are preferably established. In FIG. 3 these cross domain relations are indicated by dashed lines 8.

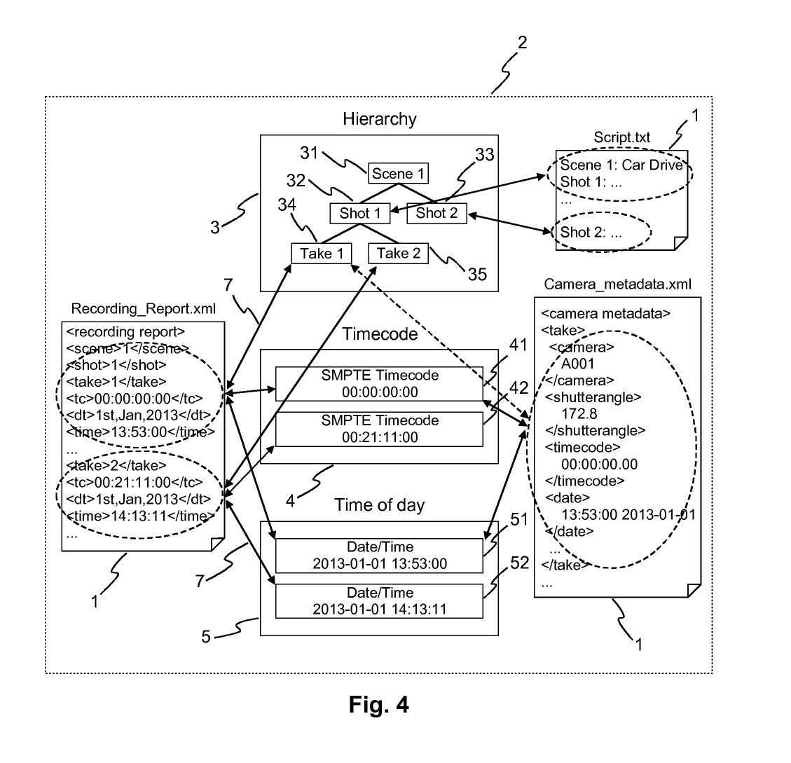

Adding different metadata files 1 to the repository 2 and connecting the information across the domains 3, 4, 5 results in a repository management structure as depicted in FIG. 4. In the figure not all references 7 are provided with reference numerals for simplicity. The metadata repository 2 has information about the added metadata of certain time entries 41, 42, 51, 52 and of certain entries in the hierarchy domain 3. Based on this data, metadata sets are composed with cross domain inheritance:

$$\begin{matrix}metadata ( hierarchyEntity ) = metadata ( hierarchyEntity & ( 1 ) \\ -> referencedFileUnits ) & \\ ⋃ & \\ metadata ( hierarchyEntity & ( 2 ) \\ -> parent ) & \\ ⋃ & \\ metadata ( hierarchyEntity & ( 3 ) \\ -> allChildren ) & \\ ⋃ & \\ metadata ( ( hierarchyEntity & ( 4 ) \\ -> referencedFileUnits ) & \\ -> allTimeReferences ) & \end{matrix}$$

A hierarchical entity thus gets metadata information from the files it has references to ((1), ‘referencedFileUnits’) and also inherits the metadata from its hierarchical tree ((2), ‘parent’; (3), allChildren). Beyond that a hierarchical entity inherits the metadata information from all the time relations of its referenced files ((4), ‘referencedFileUnits’, ‘allTimeReferences’).

The metadata sets of the time entries are composed accordingly:

$$\begin{matrix}metadata ( timeEntry ) = metadata ( timeEntry & ( 1 ) \\ -> referencedFileUnits ) & \\ ⋃ & \\ metadata ( ( timeEntry & ( 2 ) \\ -> referencedFileUnits ) & \\ -> allTimeRelations ) & \\ ⋃ & \\ metadata ( ( timeEntry & ( 3 ) \\ -> referencedFileUnits ) & \\ -> allHierarchyReferences ) & \end{matrix}$$

The metadata set of a time entry is composed of the metadata information of its referenced files ((1), ‘referencedFileUnits’) and the metadata of the time entries the referenced files have references to ((2), ‘referencedFileUnits’, ‘allTimeRelations’). But the metadata set of a time entry also inherits the information from the hierarchy references of the referenced file units ((3), ‘referencedFileUnits’, ‘allHierarchyReferences’.

Based on the gathered relations the information repository 2 is able to compose a set of all metadata of a certain time entry or a certain hierarchy entity. Beyond that it is able to check if the metadata is consistent, e.g. if the mapping between time of day and SMPTE timecode is always synchronized. The repository 2 can also check for completeness or progress. For example, the repository is able to determine if there is a recording report for all time entries or all hierarchy entities available.

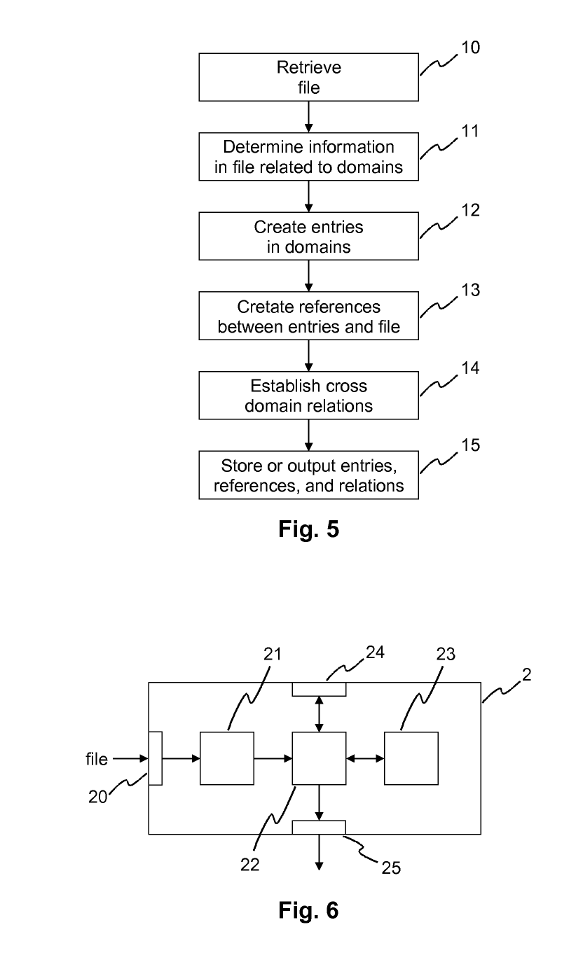

A method according to the invention for managing metadata files 1 is schematically illustrated in FIG. 5. After retrieving 10 a metadata file 1, e.g. from a network or from a local storage, information within the metadata file 1 related to at least a hierarchy domain 3 or a temporal domain 4, 5 is determined 11.

Based on the determined information within the metadata file 1 entries 31-35, 41, 42, 51, 52 in the hierarchy domain 3 and/or in the temporal domain 4, 5 are created 12. In addition, also references 7 between the entries 31-35, 41, 42, 51, 52 and the metadata file 1 are created 13. Subsequently, cross domain relations 8 between the entries 31-35, 41, 42, 51, 52 in the hierarchy domain 3 and in the temporal domain 4, 5 are established 14. Finally, the created entries 31-35, 41, 42, 51, 52, the created references 7, and the and the established cross domain relations 8 are stored 15 and/or provided to a network. If required, also the retrieved metadata file 1 is stored.

FIG. 6 depicts an apparatus 2 configured to implement the method of FIG. 5. The apparatus 2 has an input 20 for retrieving 10 a metadata file 1. A metadata analyzer 21 then determines 11 information within the metadata file 1 related to at least a hierarchy domain 3 or a temporal domain 4, 5. Based on the determined information within the metadata file 1 a data management unit 22 creates 12 entries 31-35, 41, 42, 51, 52 in the hierarchy domain 3 and/or in the temporal domain 4, 5, further creates 13 references 7 between the entries 31-35, 41, 42, 51, 52 and the metadata file 1, and establishes 14 cross domain relations 8 between the entries 31-35, 41, 42, 51, 52 in the hierarchy domain 3 and in the temporal domain 4, 5. The resulting entries 31-35, 41, 42, 51, 52, references 7, and cross domain relations are stored 15 in a storage unit 23 and/or provided to a network. Preferably the apparatus 2 further has a user interface 24 enabling a user to access and or manipulate the stored information and an output 25 for outputting information, e.g. results of queries created by the user. Of course, the input 20 may be combined with the output 25 into a bi-directional communication interface. Also, the various units of the apparatus 2 may likewise be combined or partially combined into a single unit or implemented as software running on a processor.

Although the invention has been described hereinabove with reference to a specific embodiment, it is not limited to this embodiment and no doubt further alternatives will occur to the skilled person that lie within the scope of the invention as claimed. For example, the invention is not only applicable to professional production processes. It may likewise be used for production processes performed by a consumer. Upon generation of a slide show a consumer may combine images and videos from potentially different sources with sound and text annotations.

The temporal sequence of the slide show may be controlled by a control file, which is comparable to a script. A further consumer application is the management of audio files for background music during an event.

1-9. (canceled)

10. A method for managing metadata files, the method comprising:
retrieving a metadata file;
determining information within the metadata file related to at least a hierarchy domain or a temporal domain;
creating entries in the hierarchy domain or in the temporal domain based on the determined information within the metadata file;
creating references between the entries and the metadata file;
establishing cross domain relations between the entries in the hierarchy domain and in the temporal domain;
generating sets of metadata for the entries in the hierarchy domain or in the temporal domain based on the references, the cross domain relations, and relations between entries of a domain; and
storing the created entries, the created references, and the established cross domain relations.

11. The method according to claim 10, wherein the relations between entries of a domain are parent or child relations.

12. The method according to claim 10, wherein entries in the hierarchy domain are hierarchical entities and entries in the temporal domain are time entries.

13. The method according to claim 12, wherein the hierarchical entities comprise scenes, shots, or takes, and the time entries comprise timecodes or time of day indications.

14. The method according to claim 10, wherein the metadata files comprise scripts, recording reports, or camera metadata.

15. An apparatus configured to manage metadata files, the apparatus comprising:
an input configured to retrieve a metadata file;
a metadata analyzer configured to determine information within the metadata file related to at least a hierarchy domain or a temporal domain;
a data management unit configured to create entries in the hierarchy domain or in the temporal domain based on the determined information within the metadata file, to create references between the entries and the metadata file, to establish cross domain relations between the entries in the hierarchy domain and in the temporal domain, and to generate sets of metadata for the entries in the hierarchy domain or in the temporal domain based on the references, the cross domain relations, and relations between entries of a domain; and
a storage unit configured to store the entries, the references, and the cross domain relations created and established by the data management unit.

16. The apparatus according to claim 15, further comprising a user interface configured to enable a user to access or manipulate the stored information and an output configured to output information.

17. A computer readable non-transitory storage medium having stored therein instructions enabling managing of metadata files, which, when executed by a computer, cause the computer to:
retrieve a metadata file;
determine information within the metadata file related to at least a hierarchy domain or a temporal domain;
create entries in the hierarchy domain or in the temporal domain based on the determined information within the metadata file;
create references between the entries and the metadata file;
establish cross domain relations between the entries in the hierarchy domain and in the temporal domain;
generate sets of metadata for the entries in the hierarchy domain or in the temporal domain based on the references, the cross domain relations, and relations between entries of a domain; and
store the created entries, the created references, and the established cross domain relations.

18. The method according to claim 10, further comprising receiving a user input to access or manipulate the stored information.

19. The apparatus according to claim 16, wherein the relations between entries of a domain are parent or child relations.

20. The apparatus according to claim 16, wherein entries in the hierarchy domain are hierarchical entities and entries in the temporal domain are time entries.

21. The apparatus according to claim 20, wherein the hierarchical entities comprise scenes, shots, or takes, and the time entries comprise timecodes or time of day indications.

22. The apparatus according to claim 16, wherein the metadata files comprise scripts, recording reports, or camera metadata.

23. The computer readable non-transitory storage medium according to claim 17, wherein the relations between entries of a domain are parent or child relations.

24. The computer readable non-transitory storage medium according to claim 17, wherein entries in the hierarchy domain are hierarchical entities and entries in the temporal domain are time entries.

25. The computer readable non-transitory storage medium according to claim 24, wherein the hierarchical entities comprise scenes, shots, or takes, and the time entries comprise timecodes or time of day indications.

26. The computer readable non-transitory storage medium according to claim 17, wherein the metadata files comprise scripts, recording reports, or camera metadata.

27. The computer readable non-transitory storage medium according to claim 17, wherein the instructions cause the computer to receive a user input to access and or manipulate the stored information.
